(19) United States
(12) Patent Application Publication
(10) Pub. No.: US 2015/0215631 A1
(43) Pub. Date: Jul. 30, 2015

(54) Parallel Coding with Overlapped Tiles

(71) Applicant: Broadcom Corporation, Irvine, CA (US)

(72) Inventors: Minhua Zhou, San Diego, CA (US); Yi Hu, Beeston (GB)

(21) Appl. No.: 14/600,952

(22) Filed: Jan. 20, 2015

Related U.S. Application Data
(60) Provisional application No. 61/930,736, filed on Jan. 23, 2014.

(51) Int. Cl. H04N 19/182; H04N 19/119

(52) U.S. Cl. CPC H04N 19/182; H04N 19/119

(57) ABSTRACT

A video encoding system uses overlapped tiles. The system reduces or eliminates cross-core data communication when tiles are processed in parallel on multi-core platforms. The overlapped tiles are designed to simplify the multi-core codec design by avoiding cross core data communication while still maintaining good video quality along tile boundaries.

### PRIORITY CLAIM

This application claims priority to provisional application Ser. No. 61/930,736, filed Jan. 23, 2014, which is entirely incorporated by reference.

### TECHNICAL FIELD

This disclosure relates to image coding operations.

### BACKGROUND

Rapid advances in electronics and communication technologies, driven by immense customer demand, have resulted in the widespread adoption of devices that display a wide variety of video content. Examples of such devices include smartphones, flat screen televisions, and tablet computers. Improvements in video processing techniques will continue to enhance the capabilities of these devices.

### BRIEF DESCRIPTION OF THE DRAWINGS

FIG. 1 shows an example architecture in which a source communicates with a target through a communication link.

FIG. 2 shows an example block coding structure.

FIG. 3 shows example coding logic for coding tree unit processing.

FIG. 4 shows example partitioning logic for dividing a picture into tiles.

FIG. 5 shows example parallel processing logic.

FIG. 6 shows example multicore coding circuitry based on overlapping tiles.

FIG. 7 shows example logic for in-picture partitioning with overlapped tiles.

FIG. 8 shows example logic for in-picture partitioning with overlapped tiles.

FIG. 9 shows example scanning logic.

FIG. 10 show example pixel logic for border pixel determination.

FIG. 11 shows example picture reconstruction logic.

FIG. 12 shows example picture reconstruction logic.

FIG. 13 shows example parallel encoding circuitry.

FIG. 14 shows example parallel decoding circuitry.

FIG. 15 shows example parallel encoding circuitry.

FIG. 16 shows example parallel decoding circuitry.

FIG. 17 shows example encoding logic.

FIG. 18 shows example decoding logic.

### DETAILED DESCRIPTION

The discussion below relates to techniques and architectures for multi-threaded coding operations. Coding circuitry, e.g., encoders, decoders, and/or transcoders, may receive an input stream. The input stream may contain an image or video that may be divided into multiple tiles for parallel coding operations (e.g., encoding, decoding, transcoding, and/or other coding operations) on multiple processing units. Additionally or alternatively, the input stream may include the separated tiles when received by the coding circuitry. The tiles may include overlapping regions, e.g. regions in which two or more tiles contain pixel data for any number of given locations in a given coordinate space. The overlapping regions may allow for independent coding of the tiles and subsequent reconstruction of the image. When coding operations are performed, without overlapping regions, coding artifacts (e.g., visible and/or imperceptible image defects or inconstancies across tiles) may occur at the edges of the independently coded tiles. The overlapping regions allow for consistency of coding without necessarily using memory exchanges between the processor cores performing the coding operations.

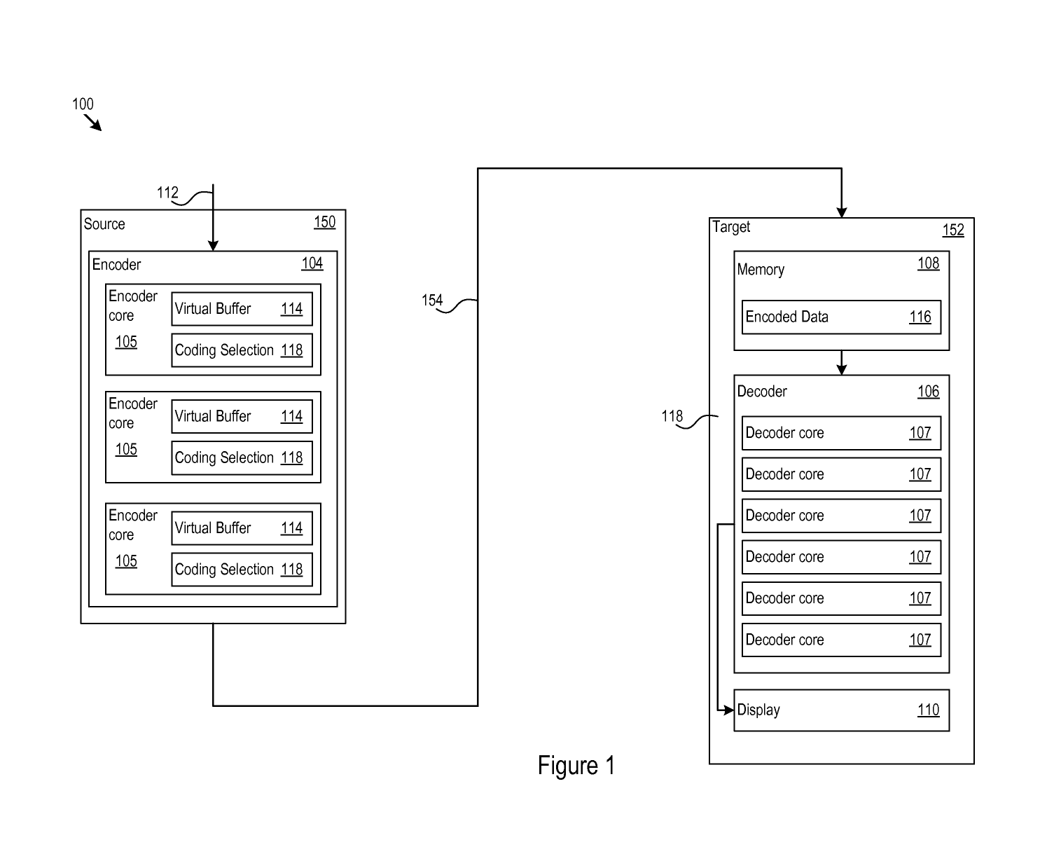

FIG. 1 shows an example architecture 100 in which a source 150 communicates with a target 152 through a communication link 154. The source 150 or target 152 may be present in any device that manipulates image data, such as a DVD or Blu-ray player, streaming media device a smartphone, a tablet computer, or any other device. The source 150 may include an encoder 104 that maintains a virtual buffer(s) 114. The target 152 may include a decoder 106, memory 108, and display 110. The encoder 104 receives source data 112 (e.g., source image data) and may maintain the virtual buffer(s) 114 of predetermined capacity to model or simulate a physical buffer that temporarily stores compressed output data. The encoder may include multiple parallel encoders 105 independently operating on tiles with overlapping regions. The decoder 106 may include multiple parallel decoders 107 operating on independent tiles. The parallel encoders 105 and/parallel decoders 107 and may include separate hardware cores and multiple codec threads running in parallel on a single hardware core.

The tiles operated on by the decoders 107 may not necessarily be the same tiles as those operated on by the encoders 105. For example, the encoders 105 may rejoin their tiles after encoding and the decoders 107 may divide the rejoined tiles. However, in some cases, the encoders 105 may pass the un-joined tiles to the decoders for operation. Additionally or alternatively, the encoders may pass un-joined tiles to the decoders 107 which may be further divided by the decoders. The number of threads used by the encoders 105 and decoders 107 may be dependent on the number of encoders/decoders available, power consumption, remaining device battery life, tile configurations, image size, and/or other factors.

The parallel encoders 105 may determine bit rates, for example, by maintaining a cumulative count of the number of bits that are used for encoding minus the number of bits that are output. While the encoders 105 may use a virtual buffer(s) 115 to model the buffering of data prior to transmission of the encoded data 116 to the memory 108, the predetermined capacity of the virtual buffer and the output bit rate do not necessarily have to be equal to the actual capacity of any buffer in the encoder or the actual output bit rate. Further, the encoders 105 may adjust a quantization step for encoding responsive to the fullness or emptiness of the virtual buffer.

The memory 108 may be implemented as Static Random Access Memory (SRAM), Dynamic RAM (DRAM), a solid state drive (SSD), hard disk, or other type of memory. The communication link 154 may be a wireless or wired connection, or combinations of wired and wireless connections. The encoder 104, decoder 106, memory 108, and display 110 may all be present in a single device (e.g. a smartphone). Alternatively, any subset of the encoder 104, decoder 106, memory 108, and display 110 may be present in a given device. For example, a streaming video playback device may include the decoder 106 and memory 108, and the display 110 may be a separate display in communication with the streaming video playback device.

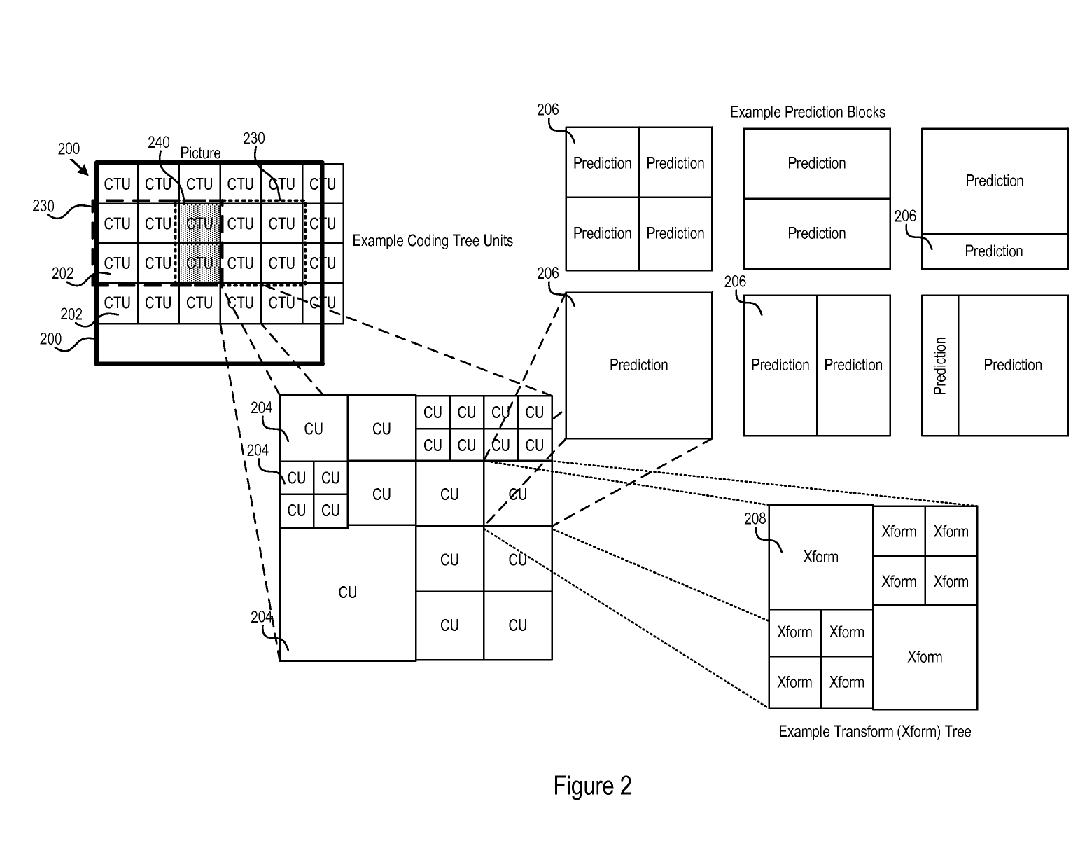

In various implementations, a coding mode may use a particular block coding structure. FIG. 2 shows an example block coding structure, in which different block sizes may be selected. As shown in FIG. 2, a picture 200 is divided into coding tree units (CTUs) 202 that may vary widely in size, e.g., 16×16 pixels or less to 64×64 pixels or more in size. At picture boundaries, CTUs 202 may cover areas that are outside of the picture. In some cases, coding circuitry may identify the regions that do not contain valid picture data. The coding circuitry may skip execution of some coding operations for portions of CTUs that are outside picture boundaries. Alternatively, the coding circuitry may fill these areas with dummy data of other fill data and perform coding operations on these areas outside the picture boundary. A CTU 202 may further decompose into coding units (CUs) 204. A CU can be as large as a CTU and the smallest CU size can be as small as desired, e.g., down to 8×8 pixels. At the CU level, a CU is split into prediction units (PUs) 206. The PU size may be smaller or equal to the CU size for intra-prediction or inter-prediction. The CU 204 may be split into transform units (TUs) 208 for transformation of a residual prediction block. TUs may also vary in size. Within a CTU, some CUs can be intra-coded, while others can be inter-coded. Such a block structure offers the coding flexibility of using different PU sizes and TUs sizes based on characteristics of incoming content. In some cases, systems may use large block size coding techniques (e.g., large prediction unit size up to, for instance, 64×64, large transform and quantization size up to, for instance, 32×32) which may support efficient coding. In some cases, the picture 200 may be divided into tiles 230 including one or more CTUs 202. Tiles 230 may be selected to include overlapping regions 240.

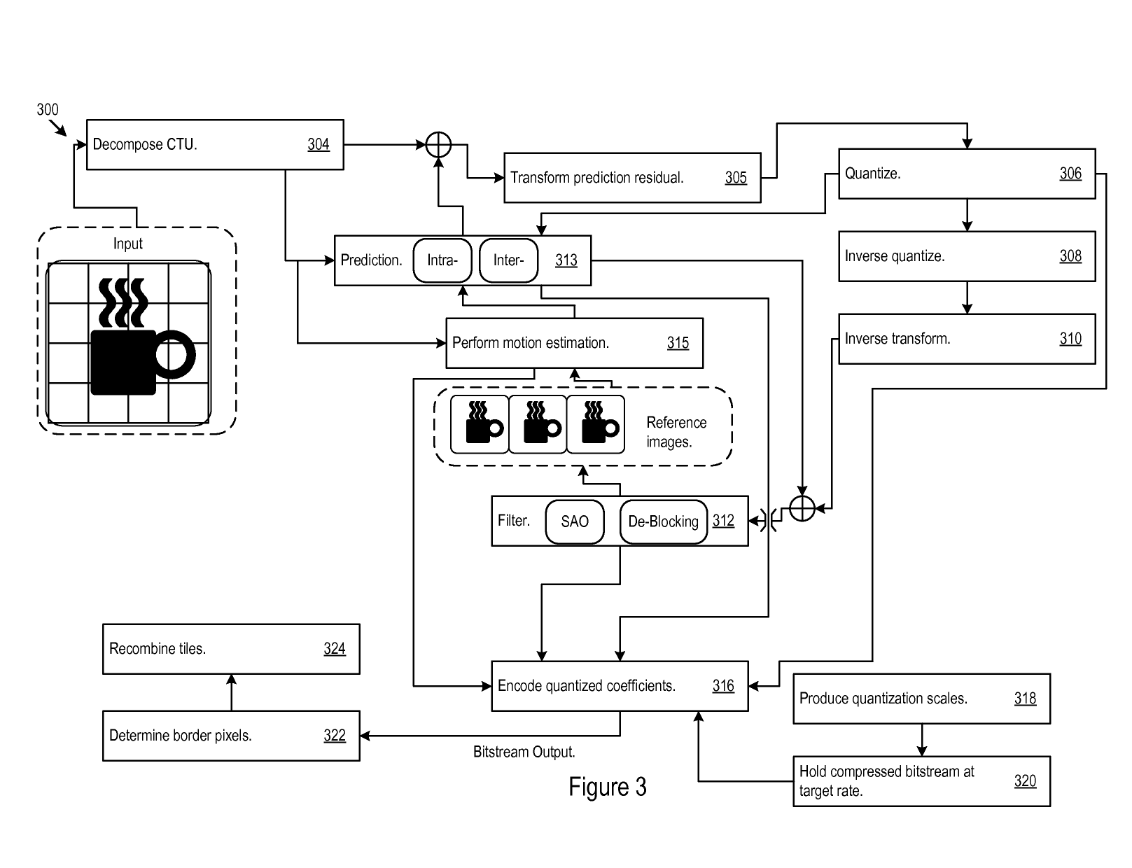

FIG. 3 shows example coding logic 300 for CTU processing, which may be implemented by coding circuitry. As shown in FIG. 3, the coding logic 300 may decompose a CTU, e.g., from a picture or decomposed tile, into CUs (304). CU motion estimation and intra-prediction are performed to allow selection of the inter-mode and/or intra-mode for the CU (313). The coding logic 300 may transform the prediction residual (305). For example, a discrete cosine transform (DCT), a discrete sine transform (DST), a wavelet transform, a Fourier transform, and/or other transform may be used to decompose the block into frequency and/or pixel component. In some cases, quantization may be used to reduce or otherwise change the number of discrete chroma and/or luma values, such as a component resulting from the transformation operation. The coding logic 300 may quantize the transform coefficients of the prediction residual (306). After transformation and quantization, the coding logic 300 may reconstruct the CU encoder via inverse quantization (308), inverse transformation (310), and filtering (312). In-loop filtering may include de-blocking filtering, Sample Adaptive Offset (SAO) filtering, and/or other filtering operations. The coding logic 300 may store the reconstructed CU in the reference picture buffer. The picture buffer may be allocated on off-chip memory to support large picture buffers. However, on-chip picture buffers may be used. At the CTU level, the coding logic 300 may encode the quantized transform coefficients along with the side information for the CTU (316), such as prediction modes data (313), motion data (315) and SAO filter coefficients, into the bitstream using a coding scheme such as, Context Adaptive Binary Arithmetic Coding (CABAC). The coding logic 300 may include rate control, which is responsible for producing quantization scales for the CTUs (318) and holding the compressed bitstream at the target rate (320).

In various implementations, if the CTU is within an overlapping region of a tile, the coding logic 300 may determine border pixels within the CTU (322). For example, the border pixels may include row or columns of pixels contiguous to non-overlapping portions of the tile. Additionally or alternatively, a pre-defined region of the CTU may be determined to include the border pixels. The border pixels may be used when the coding logic recombines the tiles into an output (324). In some cases, the region of the CTU outside the border pixels may be removed prior to recombining the tiles.

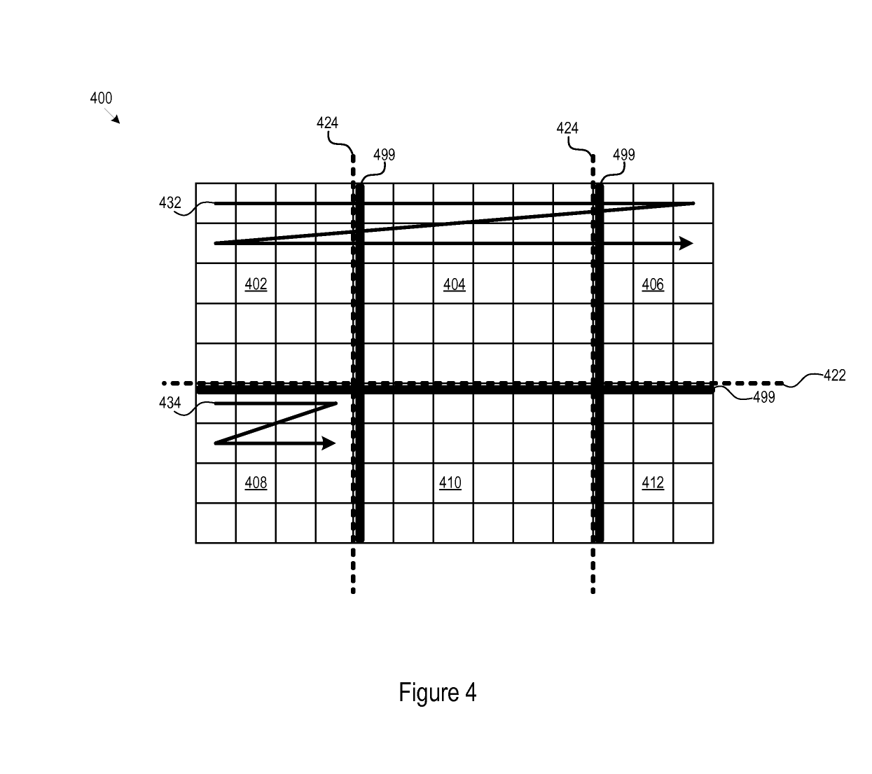

FIG. 4 shows example partitioning logic 400 for dividing a picture into tiles. The partitioning logic 400 may define boundaries, e.g., column boundaries 424, row boundaries 422, and/or other boundaries. Tiles facilitate partitioning a picture into groups of CTUs 402, 404, 406, 408, 410, 412. In some cases, the partitioning logic may also alter the CTU coding order. For example, in raster scan systems, the CTU coding order may be changed from the picture-based raster scan order 432 to tile-based rater scan order 434. Border pixels 499 for reconstruction of the picture from the tiles may be selected near the boundaries 422, 424.

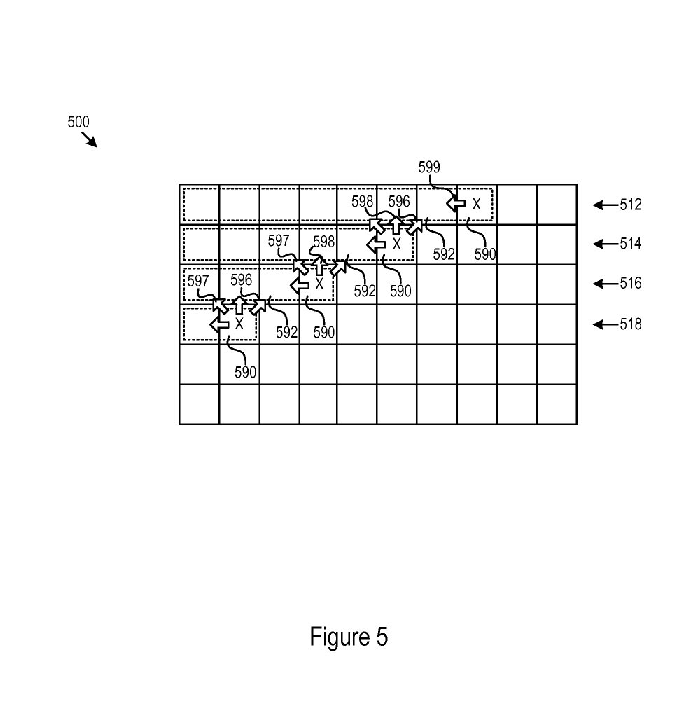

FIG. 5 shows example parallel processing logic 500. The example parallel processing logic 500 may be used to execute wavefront parallel processing of the rows of CTUs within a tile. The rows of CTUs may be processed in parallel, but may be staggered such that processing of upper rows occurs ahead of lower rows (e.g., for raster scan order systems). Dependencies for CTU processing may be in-row 599 or on CTU from a previous row 598, 597, 596. In the example, row 512, at the edge of tile and/or picture, has in-row dependencies 599 on itself. Row 514 has dependencies on itself (e.g., in-row dependencies 599) and row 512 (e.g., previous-row dependencies 598, 597, 596). Row 516 has dependencies on itself (e.g., in-row dependencies 599) and row 514 (e.g., previous-row dependencies 598, 597, 596). Row 518 has dependencies on itself (e.g., in-row dependencies 599) and row 516 (e.g., previous-row dependencies 598, 597, 596). Thus, row 512 may be processed in partially parallel with row 514, but may be started ahead of row 514. Similarly, processing order relationships may be determined and implemented for row 516 to 514 and 518 to 516. Dependencies 599, 598, 597, 596 are maintained across the CTUs. The dependencies 599, 598, 597, 596 on CTUs above the currently processed CTUs 590 may be satisfied as long as the CTUs in the row above is processed ahead of the current row, (e.g., the CTU 592 to the top left of the current CTU 590) is completed.

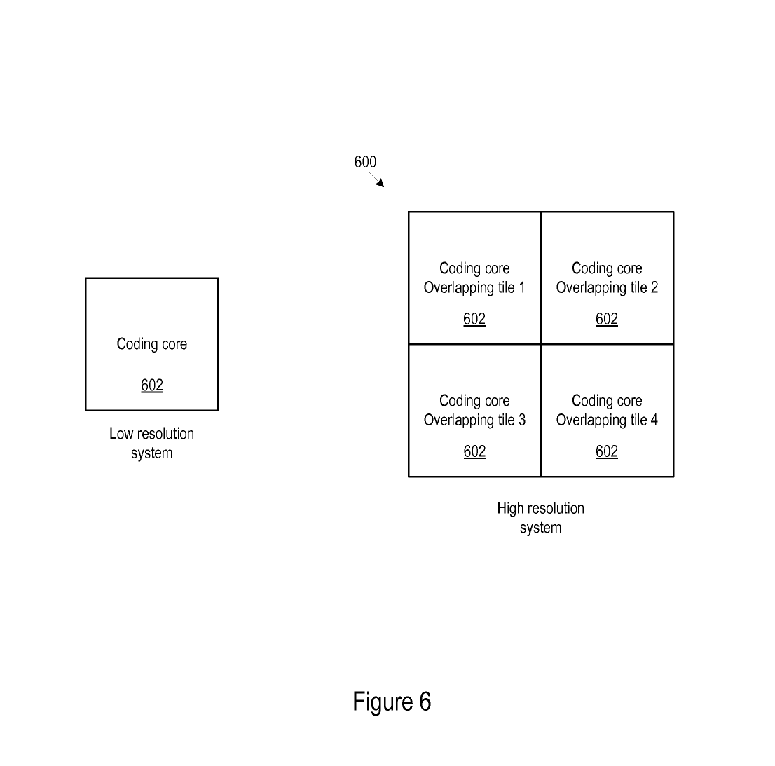

Tiles may be a tool for parallel video processing, because tiles may be used to provide pixel rate balancing on multi-core platforms, e.g., when a picture is divided into tiles balanced to the load capabilities of the differing processing cores. For example, a multi-core codec may be realized by replicating singe core codecs. Using uniformly spaced tiles, a 4K pixel by 2 k pixel (4K×2K) at 60 fps (Frame Per second) encoder can be built by replicating the 1080 p at 60 fps single core encoder four times. However, in some cases filtering, such as in-loop filtering (e.g., de-blocking and sample adaptive offset (SAO)), may be performed across tile boundaries. Therefore, an added sub-picture boundary core may be added to handle the filtering across tiles. FIG. 6 shows example multicore coding circuitry 600 based on overlapping tiles. The overlapping tiles allow filtering across tile boundaries while not necessarily using cross-core memory exchanges or a dedicated boundary processing core. The individual cores 602 may independently operate on the overlapping tiles to process a larger picture frame to create the multicore coding circuitry 600. For example, a 4K×2K image may be handled on four or more overlapping 1080 p coding cores. However, other configurations may be used.

Overlapped tiles may reduce or eliminate the cross-core data communication and facilitate building a multiple core codec by, e.g., replicating the single core design without necessarily including a boundary processing core for tile boundary filtering processing.

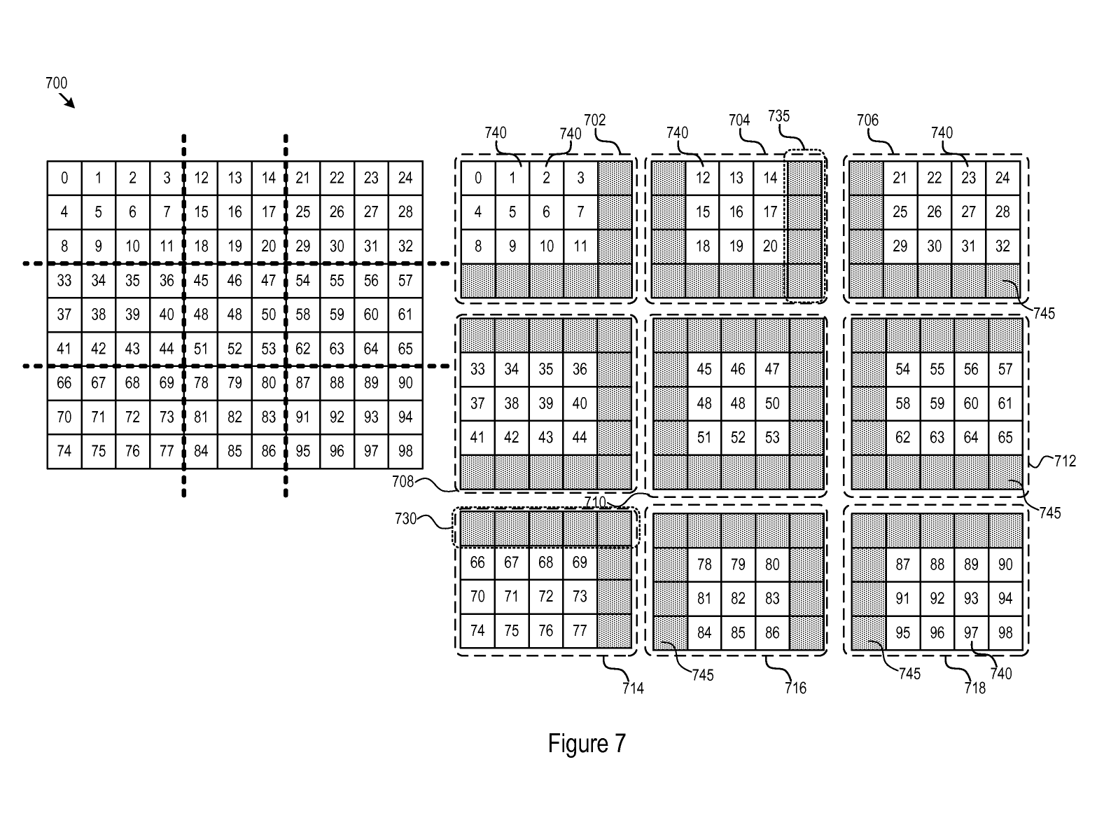

FIG. 7 shows example logic 700 for in-picture partitioning with overlapped tiles. Using the example logic 700, coding circuitry may divide a picture into multiple tiles (e.g., the tiles 702, 704, 706, 708, 710, 712, 714, 716, 718) that are extended by one CTU row 730 (in the vertical direction) or by one CTU column 735 (in the horizontal direction) in each direction, except, e.g., at picture boundaries. As shown in the example logic 700, an overlapped tile not only contains the CTUs of the current tile (e.g., the unshaded CTUs), called native tile CTUs 740, but also the extended CTUs (e.g., the shaded CTUs), called extended tile CTUs 745, which may contain data from adjacent neighboring tiles.

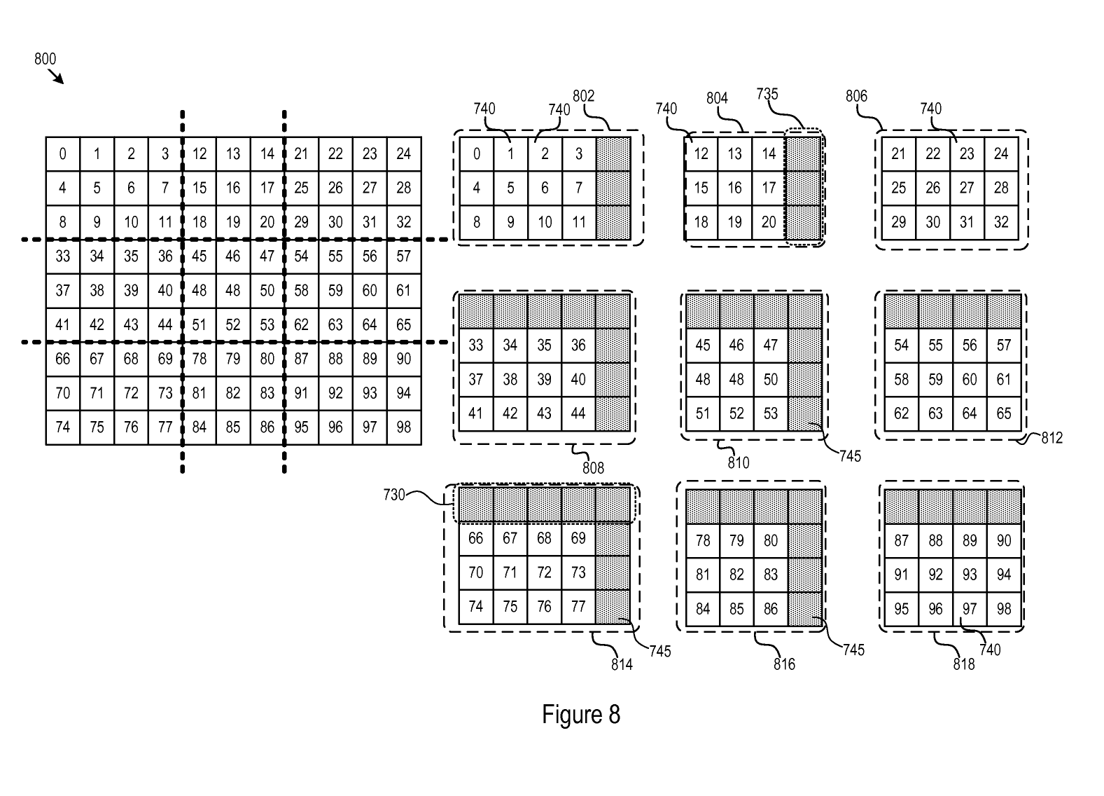

FIG. 8 shows example logic for in-picture partitioning with overlapped tiles. Additionally or alternatively, the coding circuitry may use the example logic 800 to construct an overlapped tile (e.g., the overlapped tiles 802, 804, 806, 808, 810, 812, 814, 816, 818) is to extend the tile by one CTU row 730 (in the vertical direction) or by one CTU column 735 (in the horizontal direction) in two directions except at picture boundaries. This may be accomplished by, e.g., extending tiles in the in top vertical and right horizontal directions, in top vertical and left horizontal directions, in bottom vertical and right horizontal directions, in bottom vertical and left horizontal directions, and/or in other directions for alternative scanning configurations. FIG. 8 shows the example logic being used to create overlapped tiles that have been extended by a CTU row 730 in the top vertical direction, and by a CTU column 735 in the right horizontal direction. Example logic 800 uses fewer extended tile CTUs than example logic 700 and thus uses less overhead to support overlapped tiles.

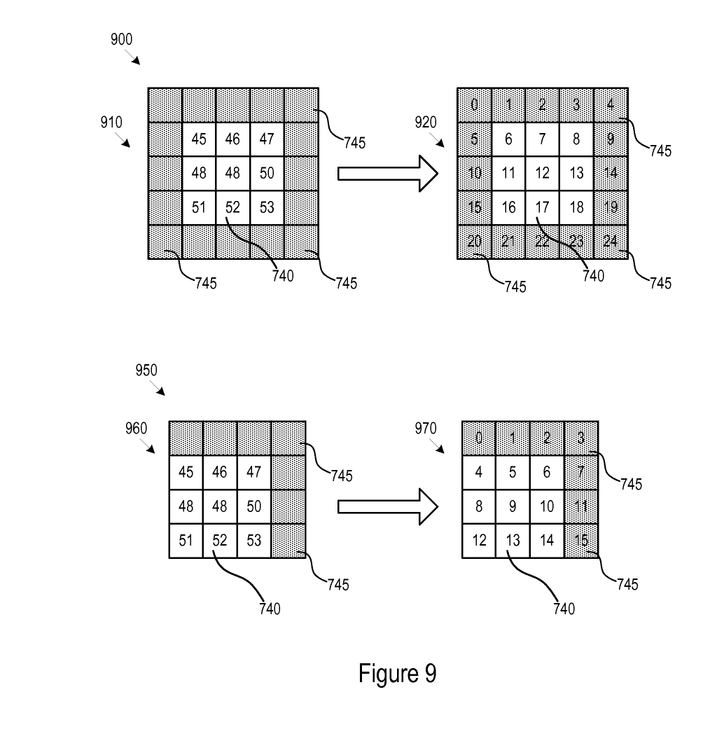

FIG. 9 shows example scanning logic 900, 950. The example scanning 900 may be used to convert the raster scanning order of the dependent tiled pictures into the raster scanning order of the independent overlapped tiles. Example scanning logic 900 shows a conversion for a tile produced using the example logic 700. For example, in tiled non-parallel codec system the CTUs in the native tile region of the unconverted tile 910 would be scanned in relation to other CTUs from other native tile regions (e.g., 45^{th}, 46^{th}, 47^{th} . . . ). The CTUs from the extended tile regions would not be included in the original tiles so these CTUs may not necessarily be included in the original scan order. The converted tile 920 includes the native tile CTUs 740 and the extended tile CTUs 745 in the converted tile's 920 scan order. Inside the converted tile 920, CTUs may be processed in raster scan order. Since the tile may be processed in parallel with other tiles, the scan order may begin at 0 (e.g. the first position in the scan). Using the example logic 900, instead of coding nine native tile CTUs 740 (CTU 45 to 53 in the original picture) a total number of 25 CTUs (native tile CTUs 740 plus extended tile CTUs 745) are coded for the tile.

Example scanning logic 950 shows a conversion for a tile produced using the example logic 800. Similarly, the native tile region of the unconverted tile 960 is included in the original scan order, but the extend tile region may be omitted. The converted tile 970 includes both the native tile CTUs 740 and the extended tile CTUs 745, and the scan order may begin at 0. The logic 950 codes fewer extended tile CTUs 745 than the logic 900.

Since tiles are extended along tile boundaries in overlapped tiles, in-loop filtering across tile boundaries can be carried out within the tile without necessarily using cross-core data communication from cores processing neighboring tiles.

In various implementations of the high efficiency video codec (HEVC), four luma columns or four luma rows along each side of a vertical or horizontal tile boundary, and the associated chroma columns or rows (depending on chroma format 4:2:0, 4:2:2 or 4:4:4) are used for the in-loop filtering across the tile boundaries. Other, HEVC implementations and other codec may use other numbers of columns and rows for in-loop filtering across tile boundaries.

The extent of the in-loop filtering across the tile boundaries may be used to determine the border pixels that may be retained from the overlapping regions. For example, in various ones of the HEVC implementations discussed above, four luma and/or chorma lines (e.g., rows and/or columns) along the boundaries may be retained as border pixels.

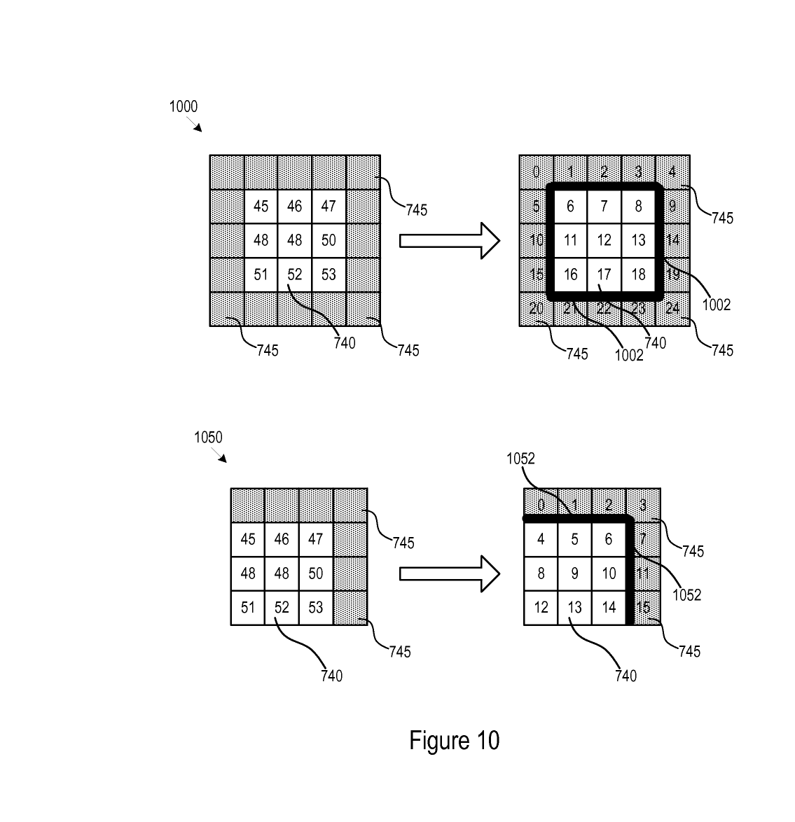

FIG. 10 show example pixel logic 1000, 1050 for border pixel determination. The coding circuitry may use the example pixel logic 1000 to determine which pixels to retain for tiles generated using the logic 700. Pixel lines 1002 contiguous to the native tile area within the extended tile area may be retained. The coding circuitry may use the example pixel logic 1050 to determine which pixels to retain for tiles generated using the logic 800. Similarly, pixel lines 1052 within the extended tiles CTUs and contiguous to the native tile CTUs may be determined to be border pixels.

An encoder may fill out data for the border pixel lines (e.g., pixel lines 1002, 1052) in a way which leads to the best visual quality around the tile boundaries after the in-loop filtering. One way to do this is to fill the area with the corresponding input picture data for this area. For the rest area of the extended tile CTUs, an encoder may fill out the data in a way which leads the best coding efficiency (e.g., to minimize the coding overhead to signal those areas in the bitstream). Also, an encoder may manage to control tiles to have similar quantization scales along tile boundaries so that the visual quality is balanced at both sides of tile boundaries.

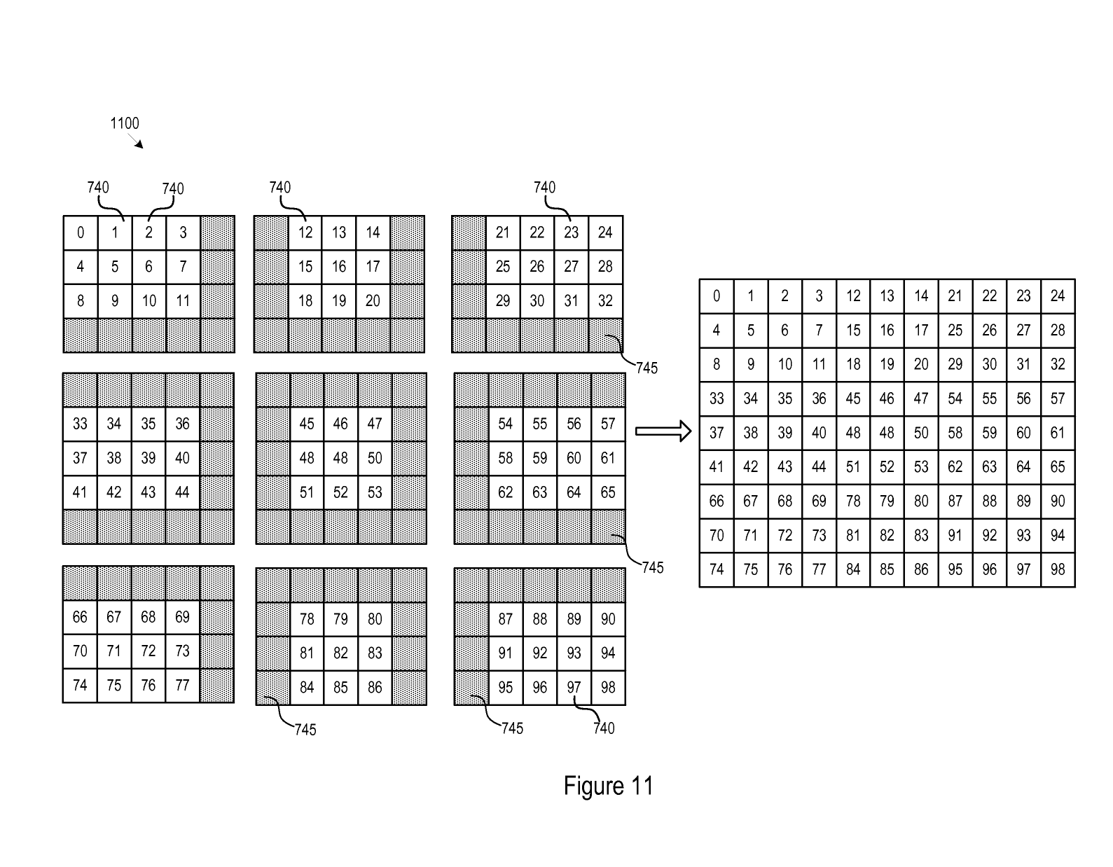

The reconstructed picture data for the extended tile CTUs 745 may be discarded when the coding circuitry uses the logic 700. Because of the redundant overlapping when the logic 700 is used, neighboring tile pairs may both include cross-border in-loop filtering after the coding operation is performed. FIG. 11 shows example picture reconstruction logic 1100. The extended tile CTUs 745 (shaded) may be discarded. The native tile CTUs 740 (unshaded) may be retained for reconstruction.

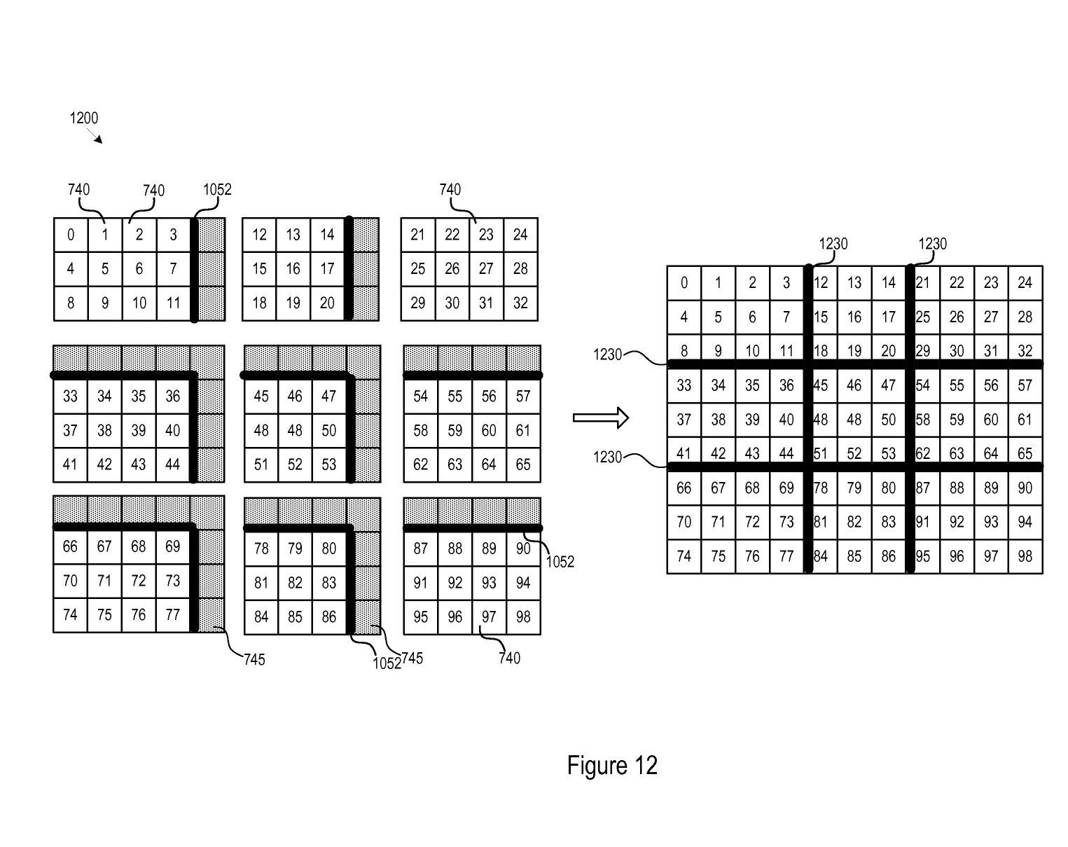

For reconstruction based on tiles generated using the example logic 800, portions of the extended tile CTUs 745 may be retained. Because one tile in a neighboring tile pair lacks extended tile CTUs for the border, cross-border in-loop filtering may not necessarily be performed for that tile. Border pixels from the tile with extended tile CTUs 745 may be retained from within the extended tile CTUs. FIG. 12 shows example picture reconstruction logic 1200. Areas of the extended tile CTUs 745 (shaded) outside of the border pixels 1230 (black line) may be discarded. The native tile CTUs 740 (unshaded) and the border pixels may be retained. The portions of the native tile CTUs (740) overlapping with border pixels may be overwritten with the border pixel values.

However, for the motion compensation there are different ways to utilize the reconstructed data in the extended tile CTUs. A flag may be signaled in the bitstream to inform the decoder how the reconstructed picture data in the extended tile CTUs is handled in the motion compensation process.

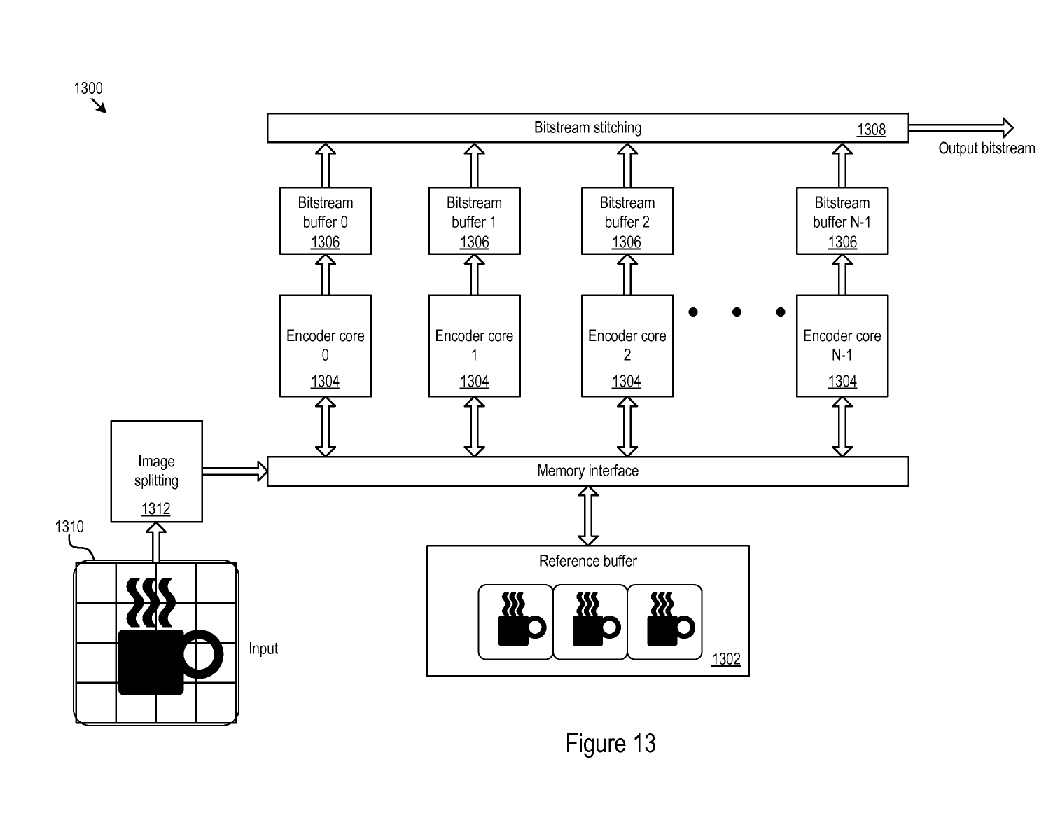

FIG. 13 shows example parallel encoding circuitry 1300. In the example parallel encoding circuitry 1300, the parallel encoders share a common reference picture buffer 1302 to perform motion compensation. The parallel encoding circuitry 1300 may divide 1312 an input picture 1310 into N overlapped tiles and send the corresponding picture data to the N encoder cores 1304 for parallel encoding. When the parallel encoding circuitry 1300 is used in conjunction with the logic 700, the cores 1304 discard the reconstructed picture data of the extended tile CTUs, and may write the reconstructed picture data for native tile CTUs back to the shared reference picture buffer 1302 to form a reference picture. The encoder cores 1304 may output the compressed bitstream data to the bitstream buffers 1306 for bitstream stitching 1308 into the output bitstream. When the parallel encoding circuitry 1300 is used in conjunction with the logic 800, the cores 1304 may write the reconstructed picture data for native tile CTUs and for the border pixels back to the shared reference picture buffer 1302 to form the reference picture.

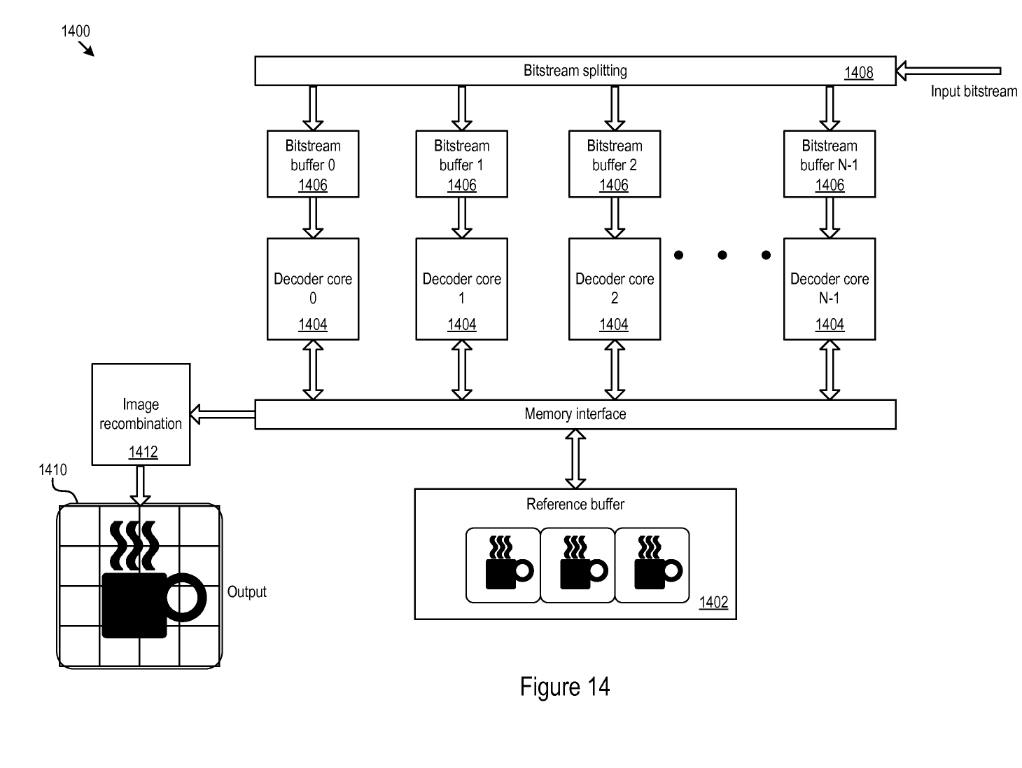

FIG. 14 shows example parallel decoding circuitry 1400. In the example parallel decoding circuitry 1400, the parallel decoders share a common reference picture buffer 1402 to perform motion compensation. The input bitstream is split 1408 and sent to buffers 1406 for the N decoder cores 1404. When the parallel decoding circuitry 1400 is used in conjunction with the logic 700, the cores 1404 discard the reconstructed picture data of the extended tile CTUs, and may write the reconstructed picture data for native tile CTUs back to the shared reference picture buffer 1402 to form a reference picture. The native tile data may then be recombined to form the reconstructed picture 1410. When the parallel decoding circuitry 1400 is used in conjunction with the logic 800, the cores 1404 may write the reconstructed picture data for native tile CTUs and for the border pixels back to the shared reference picture buffer 1402 to form the reference picture. The native tile data and border pixel data may be recombined 1412 to form the reconstructed picture 1410.

In some architectures, parallel processing cores may not necessarily have a shared reference picture buffer for motion compensation. In this case, motion vectors can be restricted not to go beyond tile boundaries so that the core can do motion compensation with its own dedicated reference tile (sub-picture) buffer.

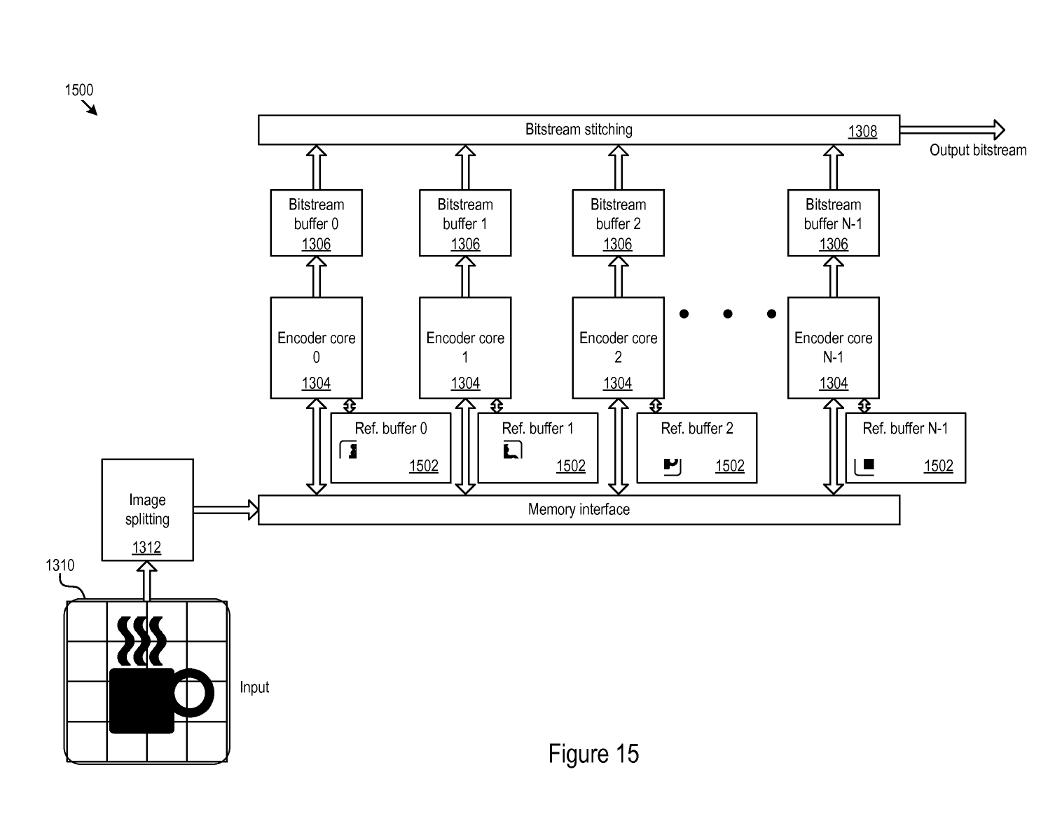

FIG. 15 shows example parallel encoding circuitry 1500. The parallel encoding circuitry 1500 may divide an input picture 1310 into N overlapped tiles and send the corresponding picture data to the N encoder cores 1304 for parallel encoding. The cores 1304 may write reference data to their individual reference buffers 1502 to perform motion compensation.

The usable border pixel lines of an overlapped tile may be limited due to limited in-loop filter length. In some cases, extended tile CTUs area outside the border pixels lines may be filled with data which is not useful for effective motion compensation. The effective reference tile area of an overlapped tile for motion compensation may be considered to be the area of the native tile CTUs and the border pixel lines. If a motion vector goes beyond the effective reference tile area, the reference samples for motion compensation may be padded with the boundary samples of the effective reference tile area (similar to the reference sample derivation in the unrestricted motion compensation around picture boundaries).

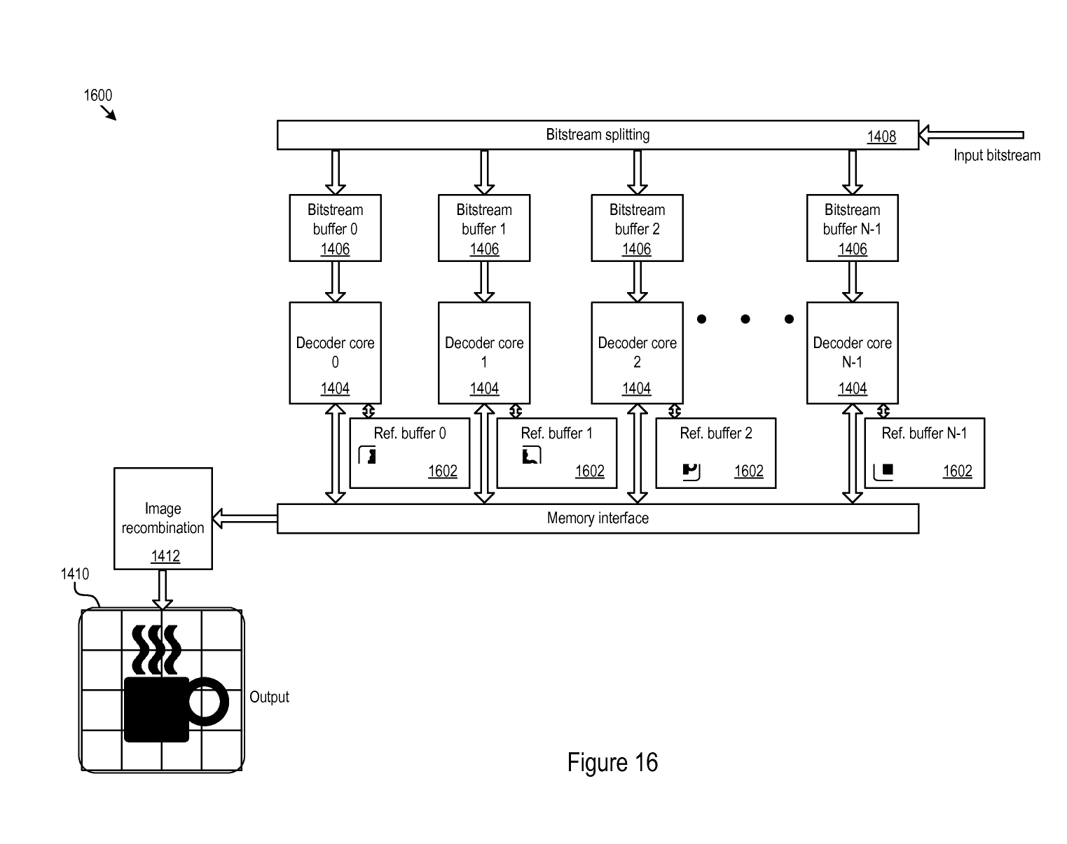

FIG. 16 shows example parallel decoding circuitry 1600. The parallel decoding circuitry 1600 may divide an input bitstream into substreams for N overlapped tiles and send the corresponding bitstream data to the N decoder cores 1404 for parallel decoding and reconstruction of the image 1410. The cores 1404 may write reference data to their individual reference buffers 1602 to perform motion compensation.

In various implementations, instead of coding the extended area of an overlapped tile as CTUs (e.g., extended tile CTUs) and re-using the same syntax as the native tile CTUs, the extended area maybe be coded with other more efficient syntaxes since the size of the effective overlapped area may be limited.

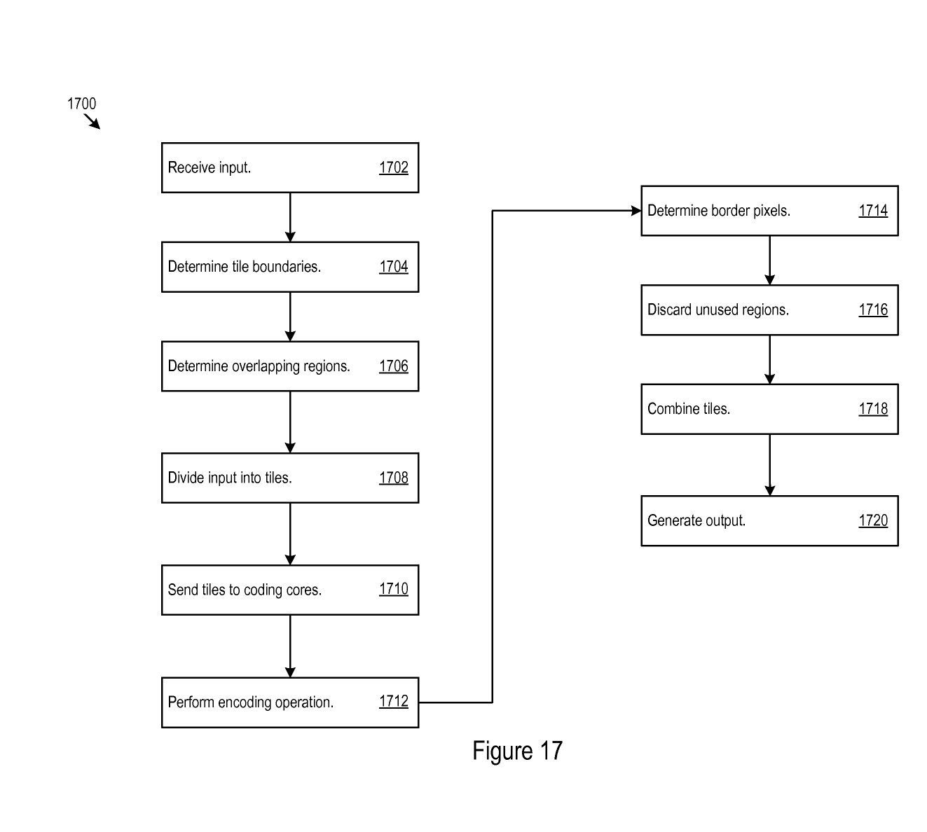

FIG. 17 shows example encoding logic 1700 which may be implemented on coding circuitry. The encoding logic 1700 may receive an input (1702). For example, the encoding logic 1700, may receive an image for encoding. The encoding logic 1700 may determine tile boundaries for the input (1704). For example, the encoding logic may identify tiles that are pre-partitioned within the input. In another example, the coding logic may determine the coding capacity of one or more available coding cores and assign tiles with sizes based on the available capacities. The encoding logic 1700 may determine overlapping regions that extend past the boundaries (1706). The encoding logic 1700 may divide the input into tiles based on the determined boundaries and the overlapping regions, and fill the pixel value for the overlapping regions (1708). The coding logic may send the tiles to coding cores (1710). The coding cores may perform an encoding operation on the tiles (1712). For example, the coding cores may perform parallel coding operations on the tiles such that the processing load of performing a coding operation on the entire input is distributed among the multiple cores. The encoding logic 1700 may determine border pixels for the tiles (1714). For example, the border pixels may include native tile areas. Additionally or alternatively, the border pixels may include pixel lines from extended tile areas when neighboring pairs of tiles include one extended tile area rather than two extended tile areas.

The encoding logic 1700 may discard unused regions (1716). For example, the encoding logic 1700 may discard extended tile areas outside border pixels lines. Further, the encoding logic 1700 may discard or overwrite native tile area that overlap with border pixel lines. Once the unused regions are discarded, the encoding logic 1700 may combine the tiles (1718). The encoding logic 1700 may use the combined tile to generate an output bit stream (1720).

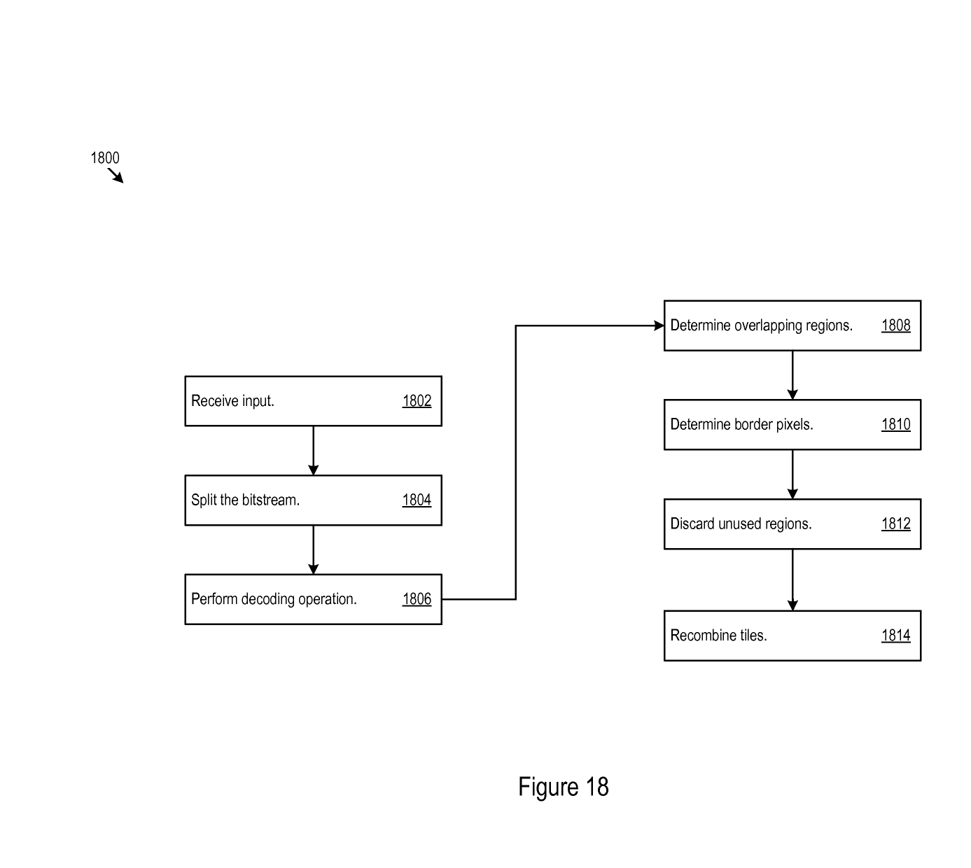

FIG. 18 shows example decoding logic 1800 which may be implemented on coding circuitry. The decoding logic 1800 may receive a bitstream (1802). The decoding logic 1800 split the bitstream (1804). For example, the decoding logic 1800 may identify separate substreams within the received bitstream. Additionally or alternatively, the decoding logic may parse a bitstream into substreams using a predetermined parsing scheme. The coding cores may perform a decoding operation on the substream to produce tiles (1806). The decoding logic 1800 may determine overlapping regions among the tiles reconstructed from the substreams (1808).

The decoding logic may determine border pixels (1810). For example, the decoding logic 1800 may determine which pixel lines from the overlapping regions and/or regions outside native tile areas to retain for image recombination. The decoding logic 1800 may discard unused regions (1812). Once the unused regions are discarded, the decoding logic 1800 may recombine the tiles into a reconstructed image (1814).

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

Various implementations have been specifically described. However, many other implementations are also possible.

What is claimed is:

1. A device comprising,
interface circuitry configured to receive an input comprising a first tile and a second tile, where the first tile includes a first region overlapping with a portion of the second tile, the first tile different than the second tile; and
coding circuitry in data communication with the interface circuitry, the coding circuitry configured to:
determine border pixels located within the first region;
after determination of the border pixels, remove first pixels other than the border pixels from the first region of the first tile; and
combine the first and second tiles.

2. The device of claim 1, wherein the coding circuitry is further configured to remove second pixels in the second tile prior to combining the first and second tiles, the second pixels overlapping with the border pixels.

3. The device of claim 1, wherein:
the coding circuitry comprises a first processor core and a second processor core; and
the coding circuitry is configured to:
perform a first coding operation the first tile using the first processor core; and
perform a second coding operation the second tile using the second processor core.

4. The device of claim 3, wherein the first processor core is configured to perform in-loop filtering using local processing data without exchanging processing data with the second processor core.

5. The device of claim 1, wherein:
the interface circuitry is configured to maintain a first communication link and a second communication link; and
the coding circuitry is configured to:
receive the first tile over the first communication link; and
receive the second tile over the second communication link.

6. The device of claim 1, wherein
the interface circuitry is configured to receive the input as a single stream; and
the coding circuitry is configured to divide the single stream into the first tile and the second tile.

7. The device of claim 1, wherein the border pixels are contiguous with third pixels within the first tile, the third pixels located outside the first region.

8. The device of claim 1, wherein the second tile comprises a second region overlapping with the first tile outside of the first region.

9. The device of claim 8, wherein the coding circuitry is configured to:
remove the second region from the second tile; and
remove the remaining pixels of the first region from the first tile.

10. The device of claim 1, wherein:
the coding circuitry comprises multiple processor cores allocated to tile processing; and
the coding circuitry is configured to assign processing of one tile to each of the multiple processor cores allocated to tile processing.

11. The device of claim 1, wherein the coding circuitry is configured to decode the first tile using a codec to determine the border pixels.

12. The device of claim 11, wherein the coding circuitry is configured to decode the second tile using the same codec prior to combining the first and second tiles.

13. The device of claim 1, wherein:
the first region comprises a line of coding tree units; and
the border pixels comprise multiple lines of pixels within the line of coding tree units.

14. The device of claim 1, wherein the coding circuitry is configured to perform an encoding operation, a decoding operation, a transcoding operation, or a combination thereof.

15. A method comprising:
receiving an input stream;
dividing the input stream into a first tile and a second tile, where the first tile contains a first region overlapping with a portion of the second tile, the first tile different from the second tile;
determining border pixels located within the first region;
removing the first region outside of the border pixels from the first tile; and
combining the first and second tiles.

16. The method of claim 15, further comprising removing second pixels in the second tile prior to combining the first and second tiles, the second pixels overlapping with the border pixels.

17. The method of claim 15, wherein determining the border pixels comprises:
processing the first tile using a codec; and
processing the second tile using the same codec.

18. The method of claim 17, further comprising:
processing the first tile using a first processor core; and
processing the second tile using a second processor core different from the first processor core.

19. A device comprising:
communication circuitry configured to receive an input stream; and
coding circuitry comprising multiple processing cores, the coding circuitry in data communication with the communication circuitry; the coding circuitry configured to:
divide the input stream into multiple tiles with multiple overlapping regions;
perform a coding operation on each of the multiple tiles on separate ones of the multiple processing cores;
responsive to the coding operations, determine border pixels in each of the multiple overlapping regions; and
combine the multiple tiles using the determined border pixels.

20. The device of claim 19, further comprising removing pixels other than the border pixels from the multiple overlapping regions prior to combining the multiple tiles.
